(19) United States
(12) Patent Application Publication
(10) Pub. No.: US 2026/0308973 A1
(43) Pub. Date: Oct. 8, 2026

(54) IGU HAVING THIN CENTER PANE WITH SAFETY FILM AND RELATED METHODS

(71) Applicant: CORNING INCORPORATED, CORNING, NY (US)

(72) Inventors: James Gregory Couillard, Ithaca, NY (US); Michael Aaron McDonald, Painted Post, NY (US); Paul George Rickerl, Endicott, NY (US); David J Robbins, Horseheads, NY (US); Eric James Shomo, Corning, NY (US)

(21) Appl. No.: 19/480,224

(22) PCT Filed: Jun. 21, 2024
(86) PCT No.: PCT/US2024/034889

§ 371 Date: Oct. 30, 2025

Related U.S. Application Data
(60) Provisional application No. 63/522,896, filed on Jun. 23, 2023.

(51) Int. Cl. E06B 3/663; E06B 3/67; E06B 3/673; E06B 3/677

(52) U.S. Cl. CPC E06B 3/66366; E06B 3/6715; E06B 3/6733; E06B 3/6775

(57) ABSTRACT

An insulating glass unit (IGU) in various aspects includes: a first pane comprising a transparent material; a second pane comprising a transparent material, the second pane configured in a spaced relation with the first pane, wherein the second pane is configured as a safety laminate, the safety laminate having: a thin glass substrate and a film adhered to the thin glass substrate along a major surface of the thin glass substrate; a third pane comprising a transparent material, wherein the third pane is configured in spaced relation from the second pane; and at least one spacer material positioned adjacent an outer edge and connecting the first pane, the second pane and the third pane, such that; a first gas cavity is defined between the spacer, the first pane and the second pane and a second gas cavity is defined between the spacer, the second pane and the third pane.

### CROSS-REFERENCE TO RELATED APPLICATIONS

This application claims the benefit of priority under 35 U.S.C. § 119 of U.S. Provisional Application No. 63/522,896 filed Jun. 23, 2023, the content of which is incorporated herein by reference in its entirety.

### FIELD OF THE DISCLOSURE

Generally, the present disclosure is directed towards embodiments of insulated glazing units (IGUs) that include tailored triple pane window configurations with desirable characteristics. More specifically, the present disclosure is directed towards embodiments of IGUs that include triple pane window systems having a center pane that is a thin laminate structure.

### BACKGROUND

Traditional triple pane windows provide improved performance in areas including: solar heat gain coefficient (SHGC) and insulation (U-values), to name a few. However, the third pane adds weight to the assembly, adds difficulty in handling/installation, and increases thickness of the glazing assembly (i.e. requiring new tooling and/or thicker frame/sash materials), among other complications.

### SUMMARY OF THE DISCLOSURE

Generally, the present disclosure is directed towards embodiments of fenestration assemblies that include tailored triple pane windows configurations with desirable characteristics. More specifically, the present disclosure is directed towards embodiments of a fenestration assembly that include insulating glass units, configured as triple pane window systems having a center pane that is a thin laminate structure (e.g. when compared to the outer panes (e.g. first pane and second pane; and/or existing triple pane windows).

In some embodiments, the film is configured with the pane to provide a safety pane, where the film has an inset from the edge of the pane. In this embodiment, the spacer contacts and is adhered to the surface of the thin glass ply.

In some embodiments, the film is configured with the pane to provide a safety pane where the film has an inset from the edge of the pane. In this embodiment, the spacer contacts and is adhered to the at least a portion of the film (e.g. at the corners), while the majority of the spacer is adhering to the surface of the thin glass ply.

In some embodiments, the film is configured with the pane to provide a safety pane where the film has a flush edge, configured to extend to the edge of the pane. In this embodiment, the spacer contacts and is adhered to the surface of the film.

In some embodiments, the film is configured with the pane to provide a safety pane where the film has a flush edge (or an inset relative to the outer edge of the pane) further wherein the region where the spacer is configured is deleted and/or removed, to enable an adhering contact between the spacer and the major surface of the thin glass ply. the spacer is applied partially to the film and partially to the glass pane.

In some embodiments, the film can be oriented on either major surface of the thin glass ply in order to configure a safety laminate. In some embodiments, the spacer extends a distance from the glass edge that is greater than the inset of the film from the same glass edge. As a result, the spacer partially covers the film leaving no exposed glass at the interior spacer edge. This provides a spacer-to-glass seal at the outside for hermiticity, while allowing for uniform optical properties within the IGU vision area. In some embodiments, the film can be applied to the pane with an inset “X” OR the film can be applied fully to the edge or inset and then removed to an inset of “X” where the spacer is applied fully to the glass pane. In some embodiment, the film can be applied to the pane fully to the edge of the pane or with an inset “X” such that the spacer is applied directly to glass pane by means of removal of the film in the location the spacer will be bonded or applied. In some embodiments, the film is used with a pocket spacer, such that the pocket spacer is applied to the center pane along its edge showing on both faces of the internal pane so that the pane can be adhered to its outer panes or additional inner panes. In this configuration, the film can be fully to the edge of the pane or inset, so that the spacer is bonded partially or fully to film, glass, or both of the interior pane.

In some embodiments, the spacer is bonded, applied, or configured to attach to the thin glass and/or the film. In some embodiments, the film is applied to a major surface of the thin glass and edge deleted along an edge region corresponding to the spacer region and outer edge of the thin glass, to define a path for the spacer application (e.g. direct bond to thin glass).

In some embodiments, the film is applied to a major surface of the thin glass and edge deleted along a channel to define a path with no film along a spacer path, with edges defined by film (e.g. extending towards the inner portion of the thin glass and towards the edge of the thin glass (optionally extending to the edge or to a portion a set distance from the edge of the thin glass)).

In some embodiments, the channel or inset is achieved by edge deletion by one or more of (as non-limiting examples): acid bath and mask, laser treatment, score and delaminate, or others.

In some embodiments, triple pane assemblies (e.g. windows) with a center pane laminate have shown improved acoustic performance (as measured by standard metrics such as ASTM E413, ASTM E1332, and ISO 717-1). In some embodiments, the via the center pane, the IGU is configured as a safety glazing in accordance with ANSI Z97.1 or EN 12600 standards. In some embodiments, the IGUs station assembly comprises a weighted sound reduction metric R_{w} of at least 35 dB, when measured in accordance with ISO 717-1 standard.

In some embodiments, the low emissivity coatings are configured to provide an improved solar heat gain coefficient and/or U-value. In some embodiments, solar heat gain coefficient is quantified and/or measured in accordance with ANSI/NFRC 200-2017_E0A1 Procedure for Determining Fenestration Product Solar Heat Gain Coefficient and Visible Transmittance at Normal Incidence. In some embodiments, thermal insulation (U-value) is quantified and/or measured in accordance with ASTM E1423-14 Standard Practice for Determining Steady State Thermal Transmittance of Fenestration Systems and/or ANSI/NFRC 100-2017_E0A2 Procedure for Determining Fenestration Product U-factors. For example, the low emissivity coating can be comprised of a combination of metals and oxides, including non-limiting examples of: silicon nitride, metallic silver, silicon dioxide, tin oxide, zirconium oxide, and/or combinations thereof, to name a few.

As used herein, a low coefficient of thermal expansion (CTE) refers to the coefficient of thermal expansion of an identified glass composition, or of a glass sheet or pane comprised thereof, as measured over a temperature range of 0-300° C., when measured in accordance with ASTM E228 or equivalent standard.

In one embodiment, the first glass layer and the second glass layer of the laminate have a coefficient of thermal expansion (CTE) over a temperature range 0-300° C. less than 7×10⁻⁶/K.

In one embodiment, at least one of the first glass layer and the second glass layer of the laminate have a CTE of less than 7×10⁻⁶/K; less than 6.5×10⁻⁶/K; less than 6×10⁻⁶/K; less than 5.5×10⁻⁶/K; less than 5×10⁻⁶/K; less than 4.5×10⁻⁶/K; less than 4×10⁻⁶/K; less than 3.5×10⁻⁶/K; or less than 3×10⁻⁶/K over a temperature range 0-300° C.

In one embodiment, at least one of the first glass layer and the second glass layer of the laminate have a CTE of greater than 2.5×10⁻⁶/K; greater than 3×10⁻⁶/K; less than 3.5×10⁻⁶/K; greater than 4×10⁻⁶/K; greater than 4.5×10⁻⁶/K; greater than 5×10⁻⁶/K; greater than 5.5×10⁻⁶/K; greater than 6×10⁻⁶/K; or greater than 6.5×10⁻⁶/K over a temperature range 0-300° C.

In one embodiment, at least one of the first glass layer and the second glass layer of the laminate have a CTE of between 2.5×10⁻⁶/K and 7×10⁻⁶/K; or between 3×10⁻⁶/K and 6.5×10⁻⁶/K, or between 2.5×10⁻⁶/K and 6×10⁻⁶/K.

In one embodiment, the first glass layer and second glass layer of the laminate comprise: a soda lime silicate glass layer; alumina borosilicate glass layer; an alkaline earth boro-aluminosilicate glass; or an alkali-free boro-aluminosilicate glass.

In one embodiment, the first glass layer comprises a soda lime silicate glass layer and the second glass layer comprises an alumina borosilicate glass layer.

In one embodiment, the thickness of the fenestration assembly is not greater than 35 mm.

In one embodiment, the first pane, second pane, third pane and fourth pane are composed of the same type of glass.

In one embodiment, the first pane and the second pane are composed of different types of glass.

In one embodiment, the interlayer is an acoustic dampening polymer configured for noise reduction. For example, the acoustic dampening polymer can be configured with multiple (e.g. 3 layers of polymer) with one layer (i.e. a central or middle layer in 3-layer polymer example) configured of a soft polymer compared to the other interlayer polymer layers. A commercially available example of an acoustic dampening polymer is QS 41 (by Solutia, a Subsidiary of Eastman Chemical Company).

In one embodiment, the first defined gap and the second defined gap are filled with non-reactive gas (e.g. configured to promote better thermal performance).

Non-limiting examples of gas in the first or second defined gap include: inert gas (e.g. Kr, Ar), air, and mixtures thereof, to name a few. In some embodiments, at least one of first defined gap and second defined gap are configured with a vacuum. In some embodiments, the fenestration assembly is configured to enable gas to communicate between the first defined gap and the second defined gap by areas including, but not limited to: tailored regions in the spacer and/or center pane that are configured to permit gas to permeate and/or communicate between the first defined gap and second defined gap region(s) (i.e. to promote dissipation/normalization of pressure differentials; to reduce, prevent, and/or eliminate bowing in the fenestration assembly; to dissipate moisture so as to reduce, prevent, and/or eliminate moisture/fog in the first defined gap and/or second defined gap, among other drivers).

In one embodiment, the fenestration assembly passes a safety test as set out in ANSI Z97.1 standard, when measured in accordance with the standard.

In one embodiment, the fenestration assembly comprises a weighted noise reduction metric R_{w} of at least 35 dB, when measured in accordance with ISO 717-1 standard.

In one embodiment, the interlayer of the center pane is not greater than 2.3 mm.

In one embodiment, at least one of the first pane, the third pane, the first glass layer of the center pane, and the second glass layer of the center pane is a chemically strengthened glass.

In one embodiment, the spacer is configured to fit between (or onto and end of each of) the second pane and third pane and define the second defined gap therein.

In one embodiment, the spacer includes a desiccant, configured therein. For example, the desiccant is configured to reduce, prevent and/or eliminate presence of moisture (e.g. fog) in the first defined gap and/or second defined gap.

In one embodiment, the IGU thickness is not greater than 40 mm. In one embodiment, the IGU assembly thickness is not greater than 35 mm. In one embodiment, the IGU assembly thickness is not greater than 30 mm.

In some embodiments, the thin glass ply configured from (as non-limiting examples): Architectural Technical Glass (ATG), EAGLE XG®; Gorilla Glass®, Lotus™ among others commercially available from Corning Incorporated. In some embodiments, one or more panes is a float glass or a fusion glass.

In one embodiment, the first pane has a thickness of not greater than 6 mm. In one embodiment, the first pane has a thickness of 3 mm.

In some embodiments, the first pane has a thickness of not greater than 12 mm; not greater than 10 mm; not greater than 8 mm; not greater than 6 mm; not greater than 4 mm; or not greater than 3 mm. In some embodiments, the first pane has a thickness of less than 12 mm; less than 10 mm less than 8 mm; less than 6 mm; less than 4 mm; or less than 3 mm. In some embodiments, the first pane has a thickness of between 3 and 12 mm; or between 4 and 10 mm; or between 6 and 8 mm; or between 3 and 6 mm.

In one embodiment, the second pane has a thickness of not greater than 2.5 mm. In one embodiment, the first pane has a thickness of 3 mm.

In some embodiments, the first, third, and fourth panes each have a thickness of not greater than 12 mm; not greater than 10 mm; not greater than 8 mm; not greater than 6 mm; not greater than 4 mm; or not greater than 3 mm. In some embodiments, the second pane has a thickness of less than 12 mm; less than 10 mm less than 8 mm; less than 6 mm; less than 4 mm; or less than 3 mm. In some embodiments, the second pane has a thickness of between 3 and 12 mm; or between 4 and 10 mm; or between 6 and 8 mm; or between 3 and 6 mm.

In some embodiments, the distance between panes (e.g. length of a first and/or second defined gap) is configured at between 10-16 mm (e.g. for argon enclosed gaps) or between 8-12 mm (e.g. for other gases and/or gaseous mixtures in the first and second defined gaps). In some embodiments, the distance between panes (e.g. length of a first and/or second defined gap) is configured at between 6-12 mm or between 4-12 mm.

In some embodiments, the second pane (thin glass ply) has a lower CTE than the first pane.

In another aspect of the present disclosure, a method is provided, comprising: aligning a first pane, a third pane, a center pane in a spaced arrangement, engaging the first pane, the third pane, and the center pane with at least one sealing member to retain the first pane, the third pane, and the center pane in sealing engagement; and concomitant with the engaging step, providing a triple pane assembly configured with a first defined gap between the first pane, the center pane, the sealing member and a second defined gap between the third pane, the center pane, and the sealing member.

In some embodiments, the method includes: replacing at least some gas in at least one of: the first defined gap and the second defined gap with a non-reactive gas or gas mixture (e.g. non-reactive and configured to promote thermal insulation across the fenestration assembly).

In some embodiments, the replacing step includes: actuating a valve (e.g. configured in the sealing member) to output an initial gas from at least one of the first defined gap and the second defined gap and input a non-reactive gas into at least one of the first defined gap and the second defined gap. For example, the valve is configurable to enable displacement of at least some of the existing gas (ambient air entrapped during engagement of the sealing member) with a non-reactive gas or gas mixture specifically configured for window gap usage.

In another aspect, a method of retrofitting a window assembly, comprising: removing a window assembly from a surface (e.g. wall, ceiling, floor) to define an opening; installing a fenestration assembly comprising a triple pane assembly having a thin laminate not exceeding 3 mm as a center pane; and improving, via the installing step, at least one window performance criterion (when comparing the fenestration assembly to the window assembly).

In some embodiments, the performance criterion includes at least one of: acoustic dampening (e.g. improved/reduced sound transmittance through the fenestration assembly); safety performance (e.g. in compliance with safety rating or improved/reduced weight with thin center pane and in compliance with safety rating); improved/reduced solar heat gain coefficient (e.g. reduced; improved/reduced weight; maintained cross-sectional assembly thickness (i.e. e.g. total thickness (assembly width) of first pane, first defined gap, center pane, second defined gap, and third pane); reduced cross-sectional thickness (i.e. total thickness (assembly width) of first pane, first defined gap, center pane, second defined gap, and third pane); emissivity (e.g. improved/reduced emissivity with application or one or more low emissivity coatings); insulation (e.g. improved/reduced thermal transfer (hot or cold) from one end of the fenestration assembly to the other end, through the cross-sectional width); light transmittance (improved/reduced light transmittance and/or improved filtering of one or more types of light); and/or combinations thereof.

One or more of the aforementioned fenestration assembly embodiments are utilizable with one or more of the aforementioned methods set forth herein.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 depicts a schematic cut-away side view of an embodiment of an IGU assembly having three panes, with the center pane comprising a safety pane, more specifically a thin glass substrate with a film applied along a first major surface of the thin pane (center pane), in accordance with an embodiment of the present disclosure.

FIG. 2 depicts a schematic cut-away side view of an embodiment of an IGU assembly having three panes, with the center pane comprising a safety pane 20, more specifically a thin glass substrate (or, thin glass ply) with a film applied along a second major surface of the thin pane (center pane), in accordance with an embodiment of the present disclosure. In some embodiments, the location of the film can be on a single major surface of a pane, or on multiple panes within a multi-paned IGU to impart overall safety characteristics and/or advantages on the IGU.

FIG. 3A-3G depict various partial plan views of an embodiment of a pane comprising thin glass and a film, illustrating various embodiments of how the pane is configured relative to the spacer, in accordance with one or more embodiments of the present disclosure.

FIG. 4 depicts a cut-away side view of an embodiment of an insulated glass unit having a thin center pane with a film applied along a major surface thereof, where the center pane is configured in pocket spacer, in accordance with one or more embodiments of the present disclosure.

FIG. 5A through 5D depict schematic cut-away side views of various embodiments of the center pane (thin pane with film) configured in a pocket spacer, in accordance with an embodiment of the present disclosure.

FIG. 6 depicts an embodiment of an IGU assembly having four panes, with the central two panes configured in accordance with one or more aspects of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. As a non-limiting example, about means less than 10% of the referenced value.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

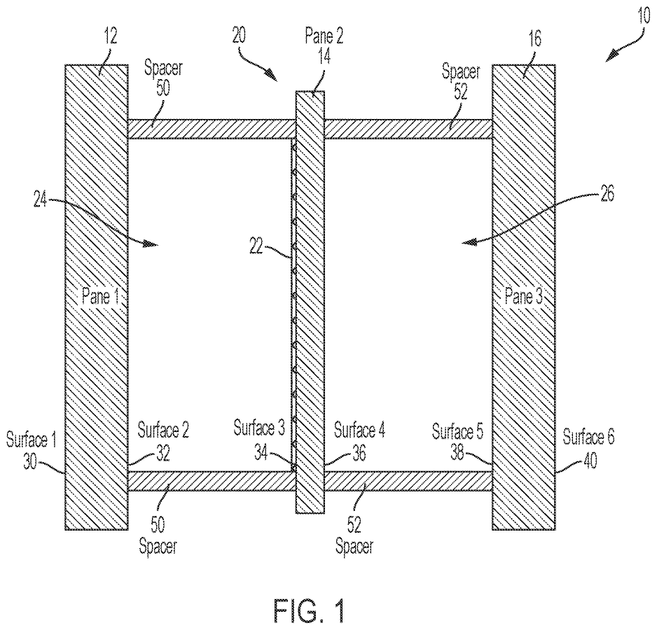

FIG. 1 depicts a schematic cut-away side view of an embodiment of an IGU assembly having three panes, with the center pane comprising a safety pane, more specifically a thin glass substrate with a film applied along a first major surface of the thin pane (center pane), in accordance with an embodiment of the present disclosure.

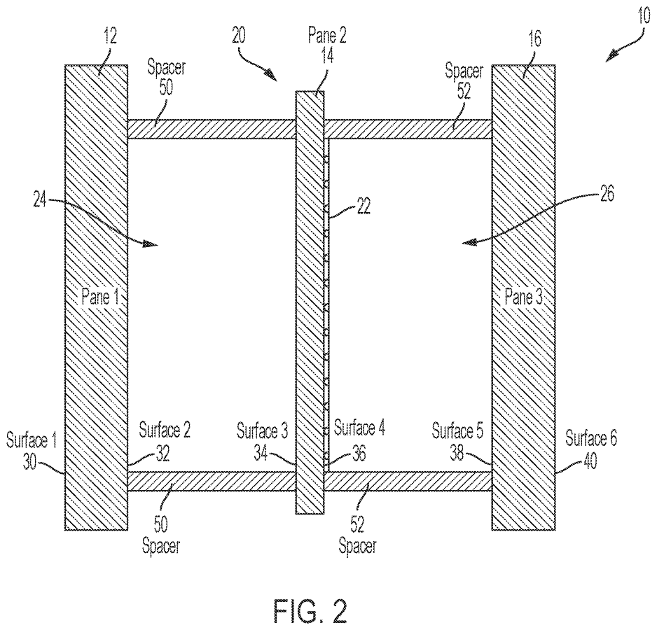

FIG. 2 depicts a schematic cut-away side view of an embodiment of an IGU assembly having three panes, with the center pane comprising a safety pane 20, more specifically a thin glass substrate (or, thin glass ply) with a film applied along a second major surface of the thin pane (center pane), in accordance with an embodiment of the present disclosure. In some embodiments, the location of the film can be on a single major surface of a pane, or on multiple panes within a multi-paned IGU to impart overall safety characteristics and/or advantages on the IGU.

Referring to FIGS. 1, 2, and 4, various embodiments of an IGU assembly 10, in accordance with aspects of the present disclosure are depicted.

FIGS. 1, 2, and 4 each depict a schematic cut-away side view of an embodiment of an IGU assembly 10 having three panes: a first pane 12, a second pane 14 (e.g., center pane), and a third pane 16. The IGU assembly 10 with three panes has size major surfaces: the first pane 12 has a first surface (S1) 30 and a second surface (S2) 32; the second pane 14 has a first major surface (S3) 34 and a second major surface (S4) 36; and the third pane 16 has a first major surface (S5) 38 and a second major surface (S6) 40. The three panes are positioned and retained in spaced relation from one another via at least one spacer 50. The first pane 12 and second pane 14 are configured in spaced relation via at least one spacer 50, such that a first gas cavity 24 is defined therebetween. The second pane 14 and the third pane are also configured in spaced relation from each other via a spacer, such that a second gas cavity 26 is defined therebetween.

In some embodiments, the gas cavities 24 and 26 are configured with the same cavity depth or cross-sectional thickness (i.e. distance between a major surface of one pane and a major surface of another pane). In some embodiments, the gas cavities 24 and 26 are configured with different cavity depths or cross-sectional thicknesses (e.g. first gas cavity 24 is deeper/thicker than second gas cavity 26 or first gas cavity 24 is shallower/thinner than second gas cavity 26).

In some embodiments, the first gas cavity 24 and second gas cavity 26 are filled with a gas. In some embodiments, the first gas cavity 24 and second gas cavity 26 are filled with an insulating gas. In some embodiments, the first gas cavity 24 and second gas cavity 26 are filled with a non-reactive gas. Some non-limiting examples of gases include argon, krypton, air, and/or combinations thereof.

Also depicted in FIG. 1 and in FIG. 2, there are two separate spacers, a first spacer 50 and a second spacer 52. As shown in FIG. 1, the first spacer 50 is configured to extend between the second major surface (S2) 32 of the first pane 12 and the first major surface (S3) 34 of the second pane 14. As shown in FIG. 2, the second spacer 52 is configured to extend between the second major surface (S4) 36 of the second pane 14 and the first major surface (S5) 38 of the third pane 16.

As depicted in FIG. 1, the second pane 14 (central pane in the triple IGU configuration) is safety pane 20 comprising a thin glass ply and a film 22 applied along the first major surface 34 (S3) of the second pane 14. As shown in FIG. 1, the safety pane 20 has a film 22 adhered to surface 34, such that it extends along a portion of surface 34. In this embodiment, the film 22 extends proximal to, but is not in contact with the spacer 50. As shown in FIG. 1, the second spacer 52 is configured to extend between (and connect) the second pane 14 via surface 4 (S4) 36 to the third pane 16 via surface 5 (S5) 38.

As depicted in FIG. 2, the second pane 14 (central pane in the triple IGU configuration) is safety pane 20 comprising a thin glass ply and a film 22 applied along the second major surface 36 (S4) of the second pane 14. The first spacer 50 is configured to extend between the second major surface (S2) 32 of the first pane 12 and the first major surface (S3) 34 of the second pane 14. As shown in FIG. 2, the safety pane 20 has a film 22 adhered to surface 36, such that it extends along a portion of surface 36. In this embodiment, the film 22 extends proximal to, but is not in contact with the second spacer 52. As shown in FIG. 2, the second spacer 52 is configured to extend between (and connect) the second pane 14 via surface 4 (S4) 36 to the third pane 16 via first major surface (S5) 38.

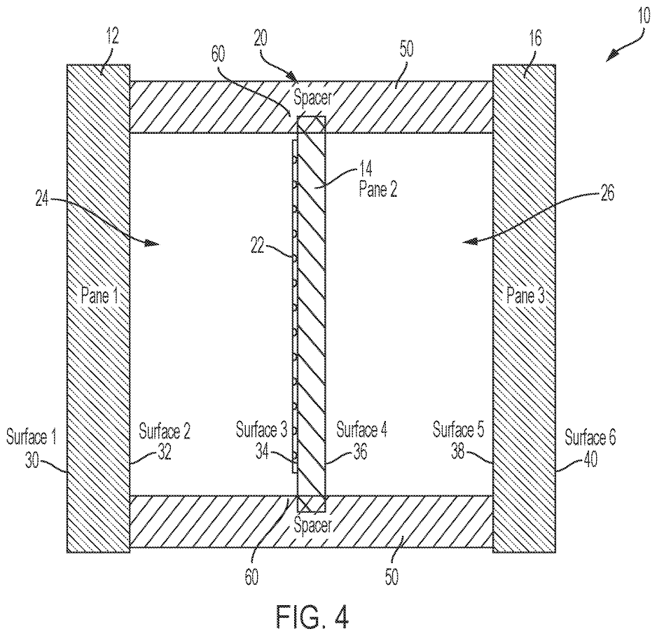

As shown in FIG. 4, the second pane 14 is configured as a safety pane 20, which has a film 22 adhered to a major surface (here, first major surface 34 (S3)), such that it extends along a portion of surface 34. In this embodiment, the safety pane 20 is configured in a first spacer 50 that is configured as a pocket spacer 60 having a groove that retains the outer perimetrical edge of the second pane 14. As depicted in FIG. 4, the film 22 is configurable with the thin glass ply of the safety film such that it is proximal to, but not in contact with, the pocket spacer groove.

In the various embodiments described herein, the film 22 can be adhered to a major surface (or major surfaces) of one or more panes with an adhesive. The adhesive can include optically clear resins and polymers to include acrylates, UV curable adhesives, polyurethanes (polyester or polyether), silicones, epoxies, 1K and 2K systems, ethylene vinyl acetates, polyvinyl acetate, cyanoacrylates, pressure sensitive adhesives, hot melt adhesives, polyamides, and polyesters. The adhesive can be solvent or water-based.

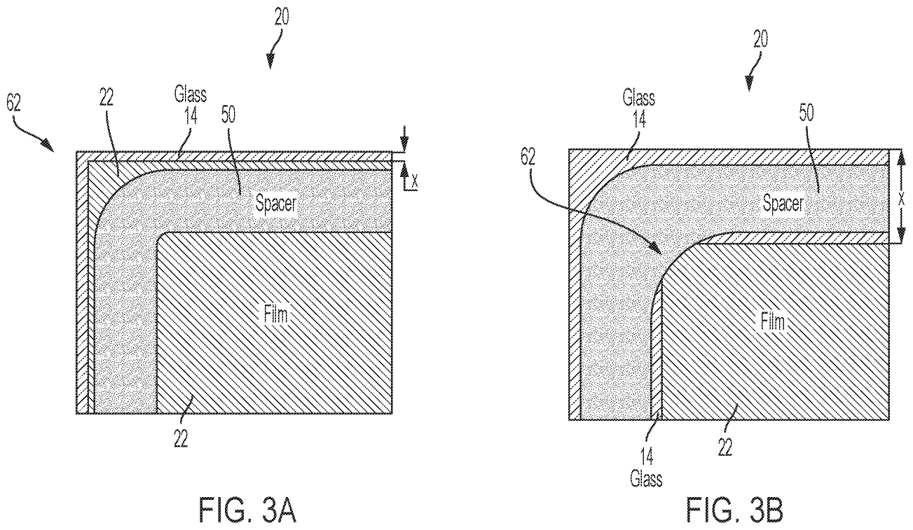

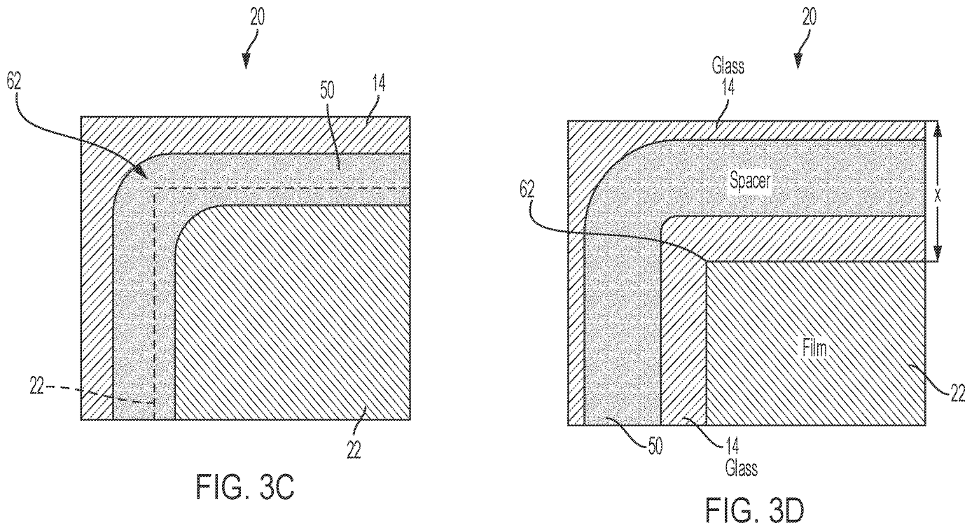

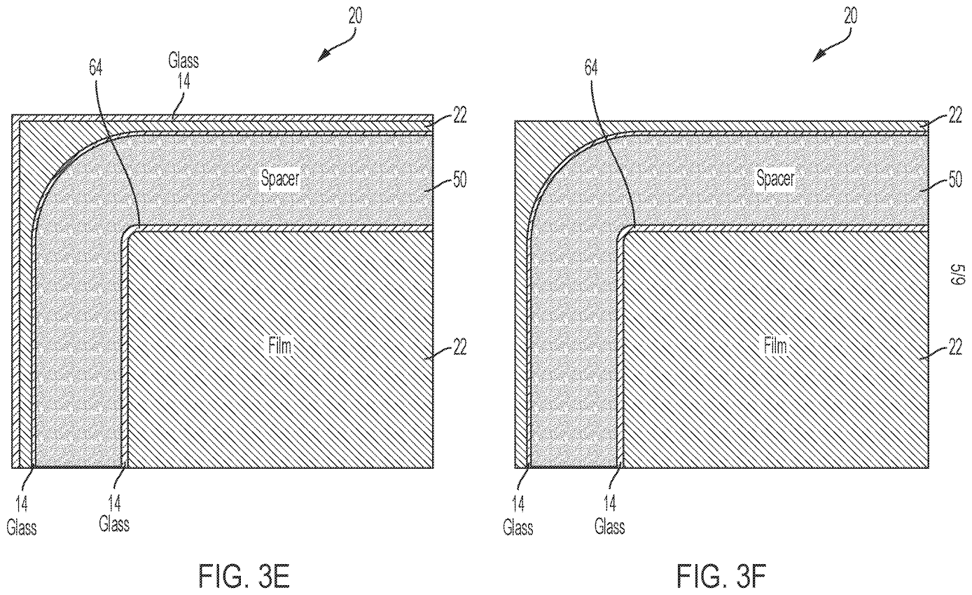

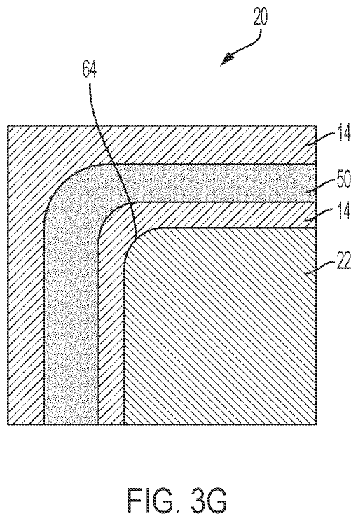

Referring to FIGS. 3A-3F various embodiments of the safety film are depicted, in accordance with one or more aspects of the present disclosure. As shown in the Figures, various configurations of the thin glass ply, the film 22, and the spacer (here, depicted as 50) are configured relative to one another, showing, as non-limiting examples: differing embodiments on the percentage of surface area covered by the safety film; differing embodiments of the amount of contact that the spacer and the film have (e.g. full contact, partial contact, and no contact); and differing edge configurations of the film 22 (arcuate, angled, or curved edges), in accordance with one or more aspects of the present disclosure.

FIG. 3A depicts an embodiment of a safety pane 20, here, a partial plan side view of the second pane 14 with spacer 50. The safety pane 20 includes a thin glass ply 14 and a safety film 22, which extends across the majority of the first surface of the second pane 14. As shown in FIG. 3A, where the spacer touches and attaches to the second pane 14, it is wholly attached to the film 22. Also, as depicted in FIG. 3A, the film 22 does not extend to the outer perimeter of the thin glass ply; rather, it is inset from the edges of the thin glass ply (e.g. such that the film 22 does not extend to the outer edges of the second pane 14). FIG. 3A depicts an embodiment where the film is applied to the thin glass ply with an inset x from the edge of the thin glass ply such that the spacer 50 is directly applied and attaches to the film 22.

FIG. 3B depicts an embodiment of a safety pane 20, here, a partial plan side view of the second pane 14 with spacer 50. The safety pane 20 includes a thin glass ply 14 and a safety film 22, which extends across the majority of the first surface of the second pane 14. As depicted in FIG. 3B, the film 22 does not extend to the outer perimeter of the thin glass ply; rather, it is inset from the edges of the thin glass ply (e.g. such that the film 22 does not extend to the outer edges of the second pane 14). FIG. 3B depicts an embodiment where the film is applied to the thin glass ply with an inset x from the edge of the thin glass ply such that the spacer 50 is directly applied and attaches to a corner portion of the film 22, though the majority (remainder) of the spacer 50 is directly attached and adhered to the major surface of the thin glass ply. As shown in FIG. 3B, the film 22 is inset such that the spacer is configured between the edge of the film 22 and the edge of the thin glass ply 14 (but for overlapping corner portions 62 of the film 22).

FIG. 3C depicts an embodiment of a safety pane 20, here, a partial plan side view of the second pane 14 with spacer 50. The safety pane 20 includes a thin glass ply 14 and a safety film 22, which extends across the majority of the first surface of the second pane 14. As depicted in FIG. 3C, the film 22 does not extend to the outer perimeter of the thin glass ply; rather, it is inset from the edges of the thin glass ply (e.g. such that the film 22 does not extend to the outer edges of the second pane 14). FIG. 3C depicts an embodiment where the film is applied to the thin glass ply with an inset x from the edge of the thin glass ply such that the spacer 50 is directly applied and attaches to both the film 22 and the thin glass ply 14, such that the spacer overlaps both the edge of the film 22 and a perimetrical portion of the thin glass ply 14 surface around the film 22 edge. The film's 22 outer edge is depicted by dotted line in FIG. 3C, with corner portion 62.

FIG. 3D depicts an embodiment of a safety pane 20, here, a partial plan side view of the second pane 14 with spacer 50. The safety pane 20 includes a thin glass ply 14 and a safety film 22, which extends across the majority of the first surface of the second pane 14. As depicted in FIG. 3D, the film 22 does not extend to the outer perimeter of the thin glass ply; rather, it is inset from the edges of the thin glass ply 14 (e.g. such that the film 22 does not extend to the outer edges of the second pane 14) and the spacer 50, with the film 22 in this embodiment configured with a corner 62.

FIG. 3E depicts an embodiment of a safety pane 20, here, a partial plan side view of the second pane 14 with spacer 50. The safety pane 20 includes a thin glass ply 14 and a safety film 22, which extends across the majority of the first surface of the second pane 14. As depicted in FIG. 3E, the film 22 does not extend to the outer perimeter of the thin glass ply; rather, it is inset from the edges of the thin glass ply 14 (e.g. such that the film 22 does not extend to the outer edges of the second pane 14) and the spacer 50, with the film 22 in this embodiment configured with a channel portion denoting a deletion or removal of a portion of the safety film 22 prior to the spacer 50 being deposited onto the second pane 20. The edge of the film portion that is inset from the corner of the spacer 50 is configured with a curved edge 64, such that it is adjacent to, but does not contact the spacer 50.

FIG. 3F depicts an embodiment of a safety pane 20, here, a partial plan side view of the second pane 14 with spacer 50. The safety pane 20 includes a thin glass ply 14 and a safety film 22, which extends across the first surface of the second pane 14. As depicted in FIG. 3F, the film 22 extends to the outer perimeter of the thin glass ply; and is also configured with a channel portion denoting a deletion or removal of a portion of the safety film 22 prior to the spacer 50 being deposited onto the second pane 20. The edge of the film portion that is inset from the corner of the spacer 50 is configured with a curved edge 64, such that it is adjacent to, but does not contact the spacer 50.

FIG. 3G depicts an embodiment of a safety pane 20, here, a partial plan side view of the second pane 14 with spacer 50. The safety pane 20 includes a thin glass ply 14 and a safety film 22, which extends across the first surface of the second pane 14 but is inset from the spacer 50, such that the film extends across most of the major surface but is positioned such that when the spacer 50 is applied to the pane 14, the film 22 is spaced at such a distance such that the spacer 50 and film 22 are not in contact with each other. As shown, the film 22 is configured with curved edges, such that it maintains an offset distance from the spacer 50.

In some embodiments, the safety pane is configured with a level of overlap, angled or arcuate configuration of the film relative to the spacer to maintain an offset distance to ensure sufficient adherence of the spacer to the pane (either partial glass to spacer coverage, or full spacer to glass coverage).

FIG. 4 depicts a cut-away side view of an embodiment of an insulated glass unit having a thin center pane with a film applied along a major surface thereof, where the center pane is configured in pocket spacer, in accordance with one or more embodiments of the present disclosure.

As shown in FIG. 4, the pocket spacer has a groove portion, which is configured to retain the second pane 14 in place (e.g. by compressive force and/or by mechanical retention within the groove). When the second pane is configured with a pocket spacer, the film 22 is configurable in multiple positions. As several, non-limiting examples, the safety film can be configured to extend across the majority (but not all of) a major surface of thin glass ply 14, as shown in FIG. 4. Alternatively, the film 22 can be configured to extend edge-to-edge across all of the major surface of the thin glass ply, or to extend into a portion of the pocket spacer, but not to the edge of the thin glass ply 14. This is shown in the following Figures.

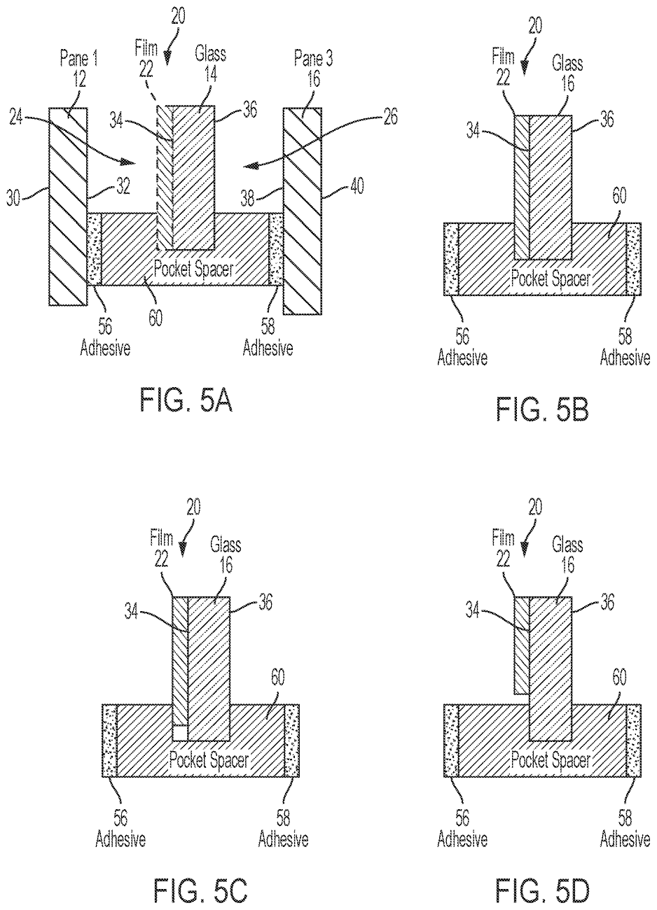

FIG. 5A through 5D depict schematic cut-away side views of various embodiments of the second pane (thin pane with film) configured in a pocket spacer, in accordance with an embodiment of the present disclosure.

FIG. 5A depicts the safety pane 20 having a thin glass ply 14 and a film 22, where the film is configured to extend to the edge of the thin glass ply 14, such that the spacer, here a pocket spacer 60, is configured to retain and contact both the film 22 and the thin glass ply 14. Also depicted in FIG. 5A (but omitted in FIGS. 5B-5D for ease in reference, are the first pane 12, and the third pane 16, where the first pane 12 is retained to the pocket spacer by adhesive 56 to the second surface 32 of the first pane; and further wherein the third pane 16 is retained on the pocket spacer 60 via adhesive 58. Here, the film position has hashmarks, as the film 22 can be positionable on either the first surface 34 of the thin glass ply 14 or the second surface 36 of the thin glass ply, for any or all of FIGS. 5B-5D as referenced herein.

FIG. 5B depicts the safety pane 20 having a thin glass ply 14 and a film 22, where the film is configured to extend to the edge of the thin glass ply 14, such that the spacer 50, here a pocket spacer 60, is configured to retain and contact both the film 22 and the thin glass ply 14. depicts in accordance with an embodiment of the present disclosure.

FIG. 5C depicts the safety pane 20 having a thin glass ply 14 and a film 22, where the film 22 is configured towards the edge of the thin glass ply 14, but with an inset such that the film does not extend to the edge of the thin glass ply 14. As shown, the pocket spacer 60 retains the second pane and is in contact with both the film 22 and the thin glass ply 22.

FIG. 5D depicts the safety pane 20 having a thin glass ply 14 and a film 22, where the film 22 is configured towards the edge of the thin glass ply 14, but with an inset such that the film does not extend to the edge of the thin glass ply 14 and also, is not retained in or touching the groove of the pocket spacer 60.

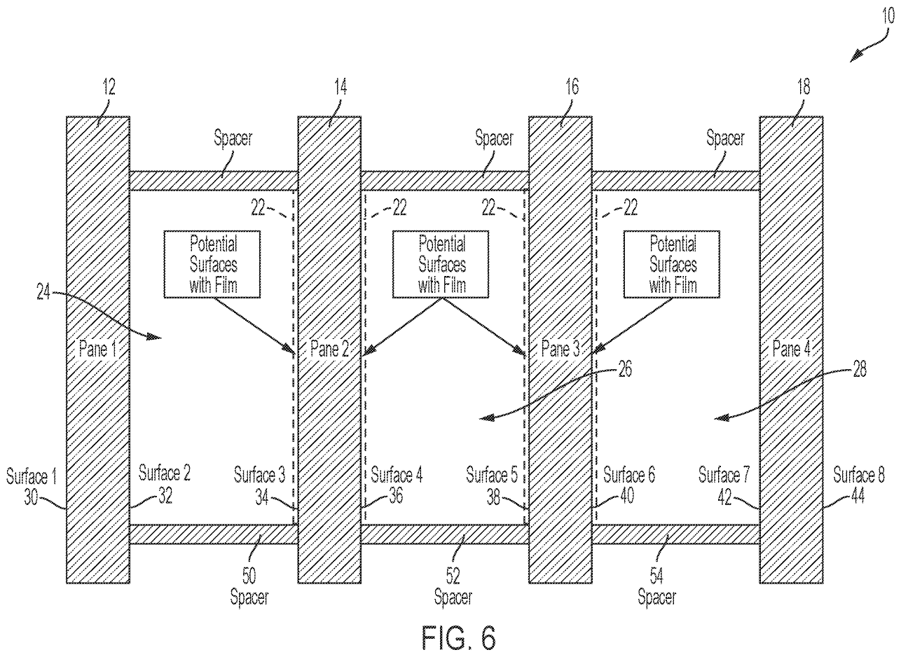

FIG. 6 depicts an embodiment of an IGU assembly having four panes, with the central two panes configured in accordance with one or more aspects of the present disclosure. More specifically, according to FIG. 6, at least one of the second pane 14 or the third pane 16 comprises a thin glass with a film 22. In some embodiments, both the second pane 14 and third pane 16 comprise thin glass with a safety film 22 positioned thereon. Also, it is noted in some embodiments, where the second pane 14 is thin glass, at least one of surface 3 (S3) 34 or surface 4 (S4) 36 has the safety film 22 positioned thereon. In some embodiments, where the third pane 16 is the thin pane, at least one of surface 5 (S5) 38 and surface 6 (S6) 40 comprise a film 22 applied thereover. In some embodiments, both panes 14, 16 are thin glass, and only one pane (e.g. second pane 14 or third pane 16) is configured with a film 22. In some embodiments, both panes 14, 16 are thin glass, and both panes (e.g. second pane 14 and third pane 16) are configured with a film 22 along one of their major faces, in accordance with an embodiment of the present disclosure. Like reference numerals depict like portions, as set forth with the triple pane IGU. Additional reference is made to the fourth pane 18, which is configured with a first surface (S7) 42 and a second surface (S8) 44. Also shown, the first gas cavity 24 is defined via first spacer 50, the second gas cavity 26 is defined by second spacer 52 and the third gas cavity 28 is defined by the third spacer 54.

### EXAMPLES

Various embodiments of the present disclosure can be better understood by reference to the following Examples which are offered by way of illustration. The present disclosure is not limited to the Examples given herein.

### Example 1—Sealing Performance

Experiments were performed to assess sealing performance of double pane IGUs and triple pane IGUs each having at least one pane with a major surface thereof disposed within a gas cavity of the IGU and with a safety film as described hereinabove disposed on the at least one pane. The IGUs were prepared according to five different configurations and multiple samples of each configuration were tested according to standard test protocols to assess sealing performance.

The configurations include a first configuration (C1) arranged as a double IGU with no low emissivity coating disposed on a first pane and with a safety film as described hereinabove disposed on a second pane. The safety film was 3M S80 8 mil safety film. The first and second panes were spaced and sealed with a spacer. The gas cavity therebetween was filled with argon gas. The first and second panes were each configured with a thickness of about 0.123″, and the gas cavity was configured with a thickness of about 0.333″. The overall IGU thickness was about 0.579″.

The configurations include a second configuration (C2) arranged as a double IGU with no low emissivity coating disposed on a first pane and with a safety film as described hereinabove disposed on a second pane. The safety film was 3M S80 8 mil safety film. The safety film was arranged with an inset relative the edge of the second pane as described above with reference to FIG. 3C. The first and second panes were spaced and sealed with a spacer. The gas cavity therebetween was filled with argon gas. The first and second panes were each configured with a thickness of about 0.121″, and the gas cavity was configured with a thickness of about 0.323″. The overall IGU thickness was about 0.565″.

The configurations include a third configuration (C3) arranged as a double IGU with a low emissivity coating disposed on a first pane and with a safety film as described hereinabove disposed on a second pane. The safety film was 3M S80 8 mil safety film. The first and second panes were spaced and sealed with a spacer. The gas cavity therebetween was filled with argon gas. The first and second panes were each configured with a thickness of about 0.129″, and the gas cavity was configured with a thickness of about 0.308″. The overall IGU thickness was about 0.566″.

The configurations include a fourth configuration (C4) arranged as a double IGU with a low emissivity coating disposed on a first pane and with a safety film as described hereinabove disposed on a second pane. The safety film was 3M S80 8 mil safety film. The safety film was arranged with an inset relative the edge of the second pane as described above with reference to FIG. 3C. The first and second panes were spaced and sealed with a spacer. The gas cavity therebetween was filled with argon gas. The first and second panes were each configured with a thickness of about 0.127″, and the gas cavity was configured with a thickness of about 0.316″. The overall IGU thickness was about 0.570″.

The configurations include a fifth configuration (C5) arranged as a triple IGU with a low emissivity coating disposed on a first/third pane and with a safety film as described hereinabove disposed on a second pane (thin glass ply). The safety film was 3M S80 8 mil safety film. The safety film was arranged with an inset relative the edge of the second pane as described above with reference to FIG. 3C. The first and second panes were spaced and sealed with a first spacer to define a first gas cavity. The second and third panes were spaced and sealed with a second spacer to define a second gas cavity. The first and second gas cavities were filled with argon gas. The first and third panes were each configured with a thickness of about 3 mm, the second pane was configured with a thickness of about 0.7794 mm, and the first and second gas cavities were each configured with a thickness of about 0.200″. The overall IGU thickness was about 0.768″.

The different configurations were tested in accordance with the following test specifications/methods: ASTM E2188-19—Standard Test Method for Insulating Glass Unit Performance; ASTM E2189-19—Standard Test Method for Testing Resistance to Fogging in Insulating Glass Units; ASTM E2190-19—Standard Specification for Insulating Glass Unit Performance and Evaluation; ASTM E546-14—Standard Test Method for Frost/Dew Point of Sealed Insulating Glass Units; and ASTM E2649-20—Standard Test Method for Determining Argon Concentration in Sealed Insulating Glass Units Using Spark Emission Spectroscopy.

The results of the testing are summarized below in Table 1. The samples in Table 1 are identified using the configuration type (e.g., first configuration (C1), second configuration (C2), etc., as described above) and a sample number (e.g., 1, 2, 3, etc.) associated with the configuration type via a hyphen. For example, sample 1 of the first configuration (C1) is identified as “C1-1,” sample 2 of the first configuration (C1) is identified as “C1-2,” and so on. Additionally, sample 1 of the second configuration (C2) is identified “C2-1,” sample 2 of the second configuration (C2) is identified as “C2-2,” and so on.

In Table 1, sufficient sealing performance can be demonstrated by (1) the frost point for all the samples must be less than or equal to −40° C. and/or (2) the final average gas concentration of the samples subjected to durability cycling must be 80% or greater, and no individual sample shall be less than 50%. As shown in Table 1, all configurations have sufficient sealing based on requirements (1) and/or (2). Gas concentration was not recorded for the samples of the fifth configuration (C5) since the outer panes included a low emissivity coating that prevented a valid argon concentration reading.

TABLE 1
Sealing Test Results

| | Initial Measurements | | | | Final Measurements | | | |
|---|---|---|---|---|---|---|---|---|
| | Frost/Dew Point | | Gas Concentration | | Frost/Dew Point | | Gas Concentration | |
| | Cavity 1 | Cavity 2 | Cavity 1 | Cavity 2 | Cavity 1 | Cavity 2 | Cavity 1 | Cavity 2 |
| Spec. No. | ° C. | ° C. | % | % | ° C. | ° C. | % | % |
| C1-1 | −46 | — | 96 | — | >−40 | — | 96 | — |
| C1-2 | −46 | — | 96 | — | >−40 | — | 96 | — |
| C1-3 | −46 | — | 96 | — | >−40 | — | 95 | — |
| C1-AVG | — | — | 96 | — | — | — | 96 | — |
| C2-1 | −46 | — | 96 | — | −40 | — | 95 | — |
| C2-2 | −40 | — | 95 | — | −40 | — | 95 | — |
| C2-3 | −40 | — | 95 | — | −40 | — | 95 | — |
| C2-AVG | — | — | 95 | — | — | — | 95 | — |
| C3-1 | <−51 | — | 96 | — | >−40 | — | 95 | — |
| C3-2 | <−51 | — | 98 | — | >−40 | — | 93 | — |
| C3-3 | <−51 | — | 95 | — | >−40 | — | 93 | — |
| C3-AVG | — | — | 96 | — | — | — | 94 | — |
| C4-1 | <−51 | — | 95 | — | >−40 | — | 94 | — |
| C4-2 | <−51 | — | 96 | — | −40 | — | 97 | — |
| C4-3 | <−51 | — | 98 | — | <−51 | — | 97 | — |
| C4-AVG | — | — | 96 | — | — | — | 96 | — |
| C5-1 | <−51 | <−51 | — | — | <−51 | <−51 | — | — |
| C5-2 | <−51 | <−51 | — | — | <−51 | <−51 | — | — |

### Example 2—Impact/Thermal Performance

Experiments were performed to assess impact/thermal performance of safety panes/laminates each having at least one thin glass substrate and a safety film as described hereinabove disposed along a major surface of the thin glass substrate. The safety panes were prepared according to three different configurations and multiple samples of each configuration were tested according to standard test protocols to assess impact/thermal performance.

The configurations include a first configuration (C1) comprising a thin glass substrate having a thickness of about 0.026″ and a first safety film applied to a major surface of the thin glass substrate. The first safety film had a thickness of about 0.005″. The first safety film was 3M S80 8 mil safety film. The overall thickness of the samples was about 0.031″. The test size was about 34″×76″.

The configurations include a second configuration (C2) comprising a thin glass substrate having a thickness of about 0.020″ and a first safety film applied to a major surface of the thin glass substrate. The first safety film had a thickness of about 0.006″. The first safety film was 3M S80 8 mil security film, the same safety film used with the first configuration (C1). The overall thickness of the samples was about 0.026″. The test size was about 34″×76″.

The configurations include a third configuration (C3) comprising a thin glass substrate having a thickness of about 0.020″ and a second safety film applied to a major surface of the thin glass substrate. The second safety film had a thickness of about 0.008″. The second safety film was Saint-Gobain Solar Gard Armorcoat® safety film. The overall thickness of the samples was about 0.029″. The test size was about 34″×76″.

The different configurations were tested in accordance with ANSI Z97.1-2015—American National Standard for Safety Glazing Materials Used in Buildings—Safety Performance Specifications and Methods of Test.

The results of the testing are summarized below in Tables 2 and 3. The samples in Tables 2 and 3 are identified using the configuration type (e.g., first configuration (C1), second configuration (C2), etc., as described above) and a sample number (e.g., 1, 2, 3, etc.) associated with the configuration type via a hyphen. For example, sample 1 of the first configuration (C1) is identified as “C1-1,” sample 2 of the first configuration (C1) is identified as “C1-2,” and so on. Additionally, sample 1 of the second configuration (C2) is identified “C2-1,” sample 2 of the second configuration (C2) is identified as “C2-2,” and so on.

In Table 2, sufficient impact performance can be demonstrated by an indication of “Pass” in the column “Test Result” for the Impact Test Results, which confirms the sample had no shear or opening greater than 3″ diameter after impact according to the test specification/method. As shown in Table 2, all configurations have sufficient impact performance.

TABLE 2
Impact Test Results

| | Overall | Drop Height | | |
|---|---|---|---|---|
| | Thickness | Classification | | |
| Spec. No. | (inches) | (inch) | Test Result | Maximum Permitted |
| C1-1 | 0.031 | 48 - Class A | Pass | No shear or opening |
| | | | | greater than 3″ |
| | | | | diameter |
| C1-2 | 0.031 | 48 - Class A | Pass | No shear or opening |
| | | | | greater than 3″ |
| | | | | diameter |
| C1-3 | 0.031 | 48 - Class A | Pass | No shear or opening |
| | | | | greater than 3″ |
| | | | | diameter |
| C1-4 | 0.031 | 48 - Class A | Pass | No shear or opening |
| | | | | greater than 3″ |
| | | | | diameter |
| C2-1 | 0.026 | 48 - Class A | Pass | No shear or opening |
| | | | | greater than 3″ |
| | | | | diameter |
| C2-2 | 0.026 | 48 - Class A | Pass | No shear or opening |
| | | | | greater than 3″ |
| | | | | diameter |
| C2-3 | 0.026 | 48 - Class A | Pass | No shear or opening |
| | | | | greater than 3″ |
| | | | | diameter |
| C2-4 | 0.026 | 48 - Class A | Pass | No shear or opening |
| | | | | greater than 3″ |
| | | | | diameter |
| C3-1 | 0.028 | 48 - Class A | Pass - No Tear (Partial | No shear or opening |
| | | | disengagement from test | greater than 3″ |
| | | | fixture) | diameter |
| C3-2 | 0.029 | 48 - Class A | Pass - No Tear | No shear or opening |
| | | | (Disengagement from | greater than 3″ |
| | | | test fixture) | diameter |
| C3-3 | 0.026 | 48 - Class A | Pass - No Tear | No shear or opening |
| | | | (Disengagement from | greater than 3″ |
| | | | test fixture) | diameter |
| C3-4 | 0.026 | 48 - Class A | Pass - No Tear (Partial | No shear or opening |
| | | | disengagement from test | greater than 3″ |
| | | | fixture) | diameter |

In Table 3, sufficient thermal performance can be demonstrated by an indication of “Pass” and/or “No bubbles or delamination” in the column “Test Result” for the Boil/Bake Test Results, which confirms the sample had no bubbles or delaminations more than ½” from the outer surface. As shown in Table 3, all configurations have sufficient thermal performance.

TABLE 3
Thermal (Boil/Bake) Test Results

| | Overall | | |
|---|---|---|---|
| | Thickness | | |
| Spec. No. | (inches) | Test Result | Maximum Permitted |
| C1-1 | 0.031 | No bubbles or delamination | No bubbles or delaminations more |
| | | | than ½″ from outer surface |
| C1-2 | 0.031 | No bubbles or delamination | No bubbles or delaminations more |
| | | | than ½″ from outer surface |
| C1-3 | 0.031 | No bubbles or delamination | No bubbles or delaminations more |
| | | | than ½″ from outer surface |
| C2-1 | 0.026 | No bubbles or delamination | No bubbles or delaminations more |
| | | | than ½″ from outer surface |
| C2-2 | 0.026 | No bubbles or delamination | No bubbles or delaminations more |
| | | | than ½″ from outer surface |
| C2-3 | 0.026 | No bubbles or delamination | No bubbles or delaminations more |
| | | | than ½″ from outer surface |
| C3-1 | 0.029 | Pass | No bubbles or defects more than |
| | | | ½″ from outer surface |
| C3-2 | 0.029 | Pass | No bubbles or defects more than |
| | | | ½″ from outer surface |
| C3-3 | 0.029 | Pass | No bubbles or defects more than |
| | | | ½″ from outer surface |

### Example 3—Energy Start Compliance

Modeling was performed to estimate compliance with ENERGY STAR v7 for the IGU arranged in the fifth configuration of Example 1. The modeling assumptions include: (1) the first and third panes each configured with a thickness of approximately ⅛″, (2) the second pane configured with a thickness of approximately 0.5 mm and comprising a safety film disposed on a surface(s) of the second pane within the gas cavities, (3) a low emissivity coating on the first and third panes (e.g., Cardinal LoE2-270), (4) the gas cavities filled with argon, and (5) results from modeling using WINDOW 7.7 software (e.g., downloaded from https://windows.lbl.gov/window-software-downloads).

The results shown below in Table 4 estimate the thermal performance (e.g., Ug) of a thin glass triple IGU arranged in the fifth configuration of Example 1. The results include incremental values for the thicknesses of the gas cavities, the corresponding incremental values for the overall width of the IGU, and the estimated thermal performance (Ug).

TABLE 4
Thermal Performance of a Thin Glass Triple IGU

| Ar gaps (in.) | IG width (in.) | Ug |
|---|---|---|
| 0.1 | 0.456 | 0.36 |
| 0.2 | 0.656 | 0.23 |
| 0.3 | 0.856 | 0.17 |
| 0.4 | 1.056 | 0.14 |
| 0.45 | 1.156 | 0.13 |
| 0.5 | 1.256 | 0.12 |
| 0.55 | 1.356 | 0.12 |
| 0.6 | 1.456 | 0.12 |
| 0.7 | 1.656 | 0.12 |
| 0.8 | 1.856 | 0.13 |
| 1 | 2.256 | 0.13 |

ENERGY STAR v7 requires U-values of <0.26 BTU/hour/ft2/° F. in North and N. Central zones. The thin glass triple IGUs disclosed herein can achieve center-of-glass U-values as low as 0.12. With appropriate choices of spacers and framing, this enables windows which are ENERGY STAR compliant.

Many variations and modifications may be made to the above-described embodiments of the disclosure without departing substantially from the spirit and various principles of the disclosure. All such modifications and variations are intended to be included herein within the scope of this disclosure and protected by the following claims.

1-65. (canceled)

66. An insulating glass unit (IGU), comprising:
a first pane comprising a transparent material;
a second pane comprising a transparent material, the second pane configured in a spaced relation with the first pane, wherein the second pane is configured as a safety laminate, the safety laminate having:
a thin glass substrate; and
a film adhered to the thin glass substrate along a major surface of the thipn glass substrate;
a third pane comprising a transparent material, wherein the third pane is configured in spaced relation from the second pane; and
at least one spacer material positioned adjacent an outer edge and connecting the first pane, the second pane and the third pane, such that:
a first gas cavity is defined between the at least one spacer material, the first pane, and the second pane and
a second gas cavity is defined between the at least one spacer material, the second pane, and the third pane.

67. The IGU of claim 66, wherein the thin glass substrate comprises a thickness of at least 0.4 mm to not greater than 1.6 mm.

68. The IGU of claim 66, wherein the film is configured with a polymer portion and an adhesive portion.

69. The IGU of claim 66, wherein the at least one spacer material comprises a pocket spacer, wherein the pocket spacer comprises a body defined by: a first attachment side; a second attachment side, and an upper edge having a groove defined therein.

70. The IGU of claim 69, wherein the second pane is configured to fit into the groove of the pocket spacer, such that the pocket spacer is configured perimetrically around the outer edge of the second pane.

71. The IGU of claim 69, wherein the pocket spacer is configured to retain a thin glass edge of the second pane, and further wherein, the pocket spacer does not contact the film.

72. The IGU of claim 69, wherein the film is configured to correspond to the same footprint as the thin glass substrate but with corners of the film configured with chamfers, radii, or edge cuts to define non-filmed corners of the thin glass substrate.

73. The IGU of claim 69, wherein the film is configured with an inset relative to the thin glass substrate, such that the film has a smaller areal dimension than the thin glass substrate, such that the film extends along a surface of the thin glass substrate but does not extend to edges of the thin glass substrate.

74. The IGU of claim 69, wherein the film is inset by a distance X1 from edges of the safety laminate, the pocket spacer extends a distance X2>X1 from the edges of the safety laminate, such that a film edge is covered by the pocket spacer in its entirety.

75. The IGU of claim 66, wherein the thin glass substrate is not strengthened.

76. The IGU of claim 66, wherein the film has a thickness of at least 0.15 mm and not greater than 0.5 mm.

77. The IGU of claim 66, wherein the second pane has a thickness of not greater than 2.7 mm.

78. The IGU of claim 66, wherein the film is further configured with a color, a tint, a reflective layer, acoustic dampening, or combinations thereof.

79. The IGU of claim 66, wherein the first pane and the third pane have a thickness of at least 2 mm to not greater than 10 mm.

80. The IGU of claim 66, further wherein the IGU comprises a low emissivity coating on at least one of: a first major surface of the first pane, a second major surface of the second pane, or combinations thereof.

81. The IGU of claim 66, wherein the thin glass substrate has a coefficient of thermal expansion (CTE) of less than 7×10⁻⁶/K.

82. The IGU of claim 66, wherein the first pane, the thin glass substrate of the second pane, and the third pane are glass.

83. The IGU of claim 66, wherein the first pane comprises a soda lime silicate glass layer, the second pane comprises an alumina borosilicate glass layer, and the third pane comprises a sodalime silicate glass layer.

84. The IGU of claim 66, wherein a total thickness of the IGU is not greater than 35 mm.

85. A method, comprising:
depositing a first bead of a spacer material perimetrically along a glass-side of a thin glass safety laminate;
adhering a first pane to the first bead of the spacer material on the thin glass safety laminate to define a double IGU having a first gas cavity defined between the first pane, the thin glass safety laminate, and the first bean of the spacer material;
depositing a second bead of the spacer material perimetrically along a second side of the thin glass safety laminate;
adhering a third pane to the second bead to define a triple pane IGU having a second gas cavity configured between a second spacer, the thin glass safety laminate, and the third pane.
